(19) United States
(12) Patent Application Publication
(10) Pub. No.: US 2008/0053977 A1
(43) Pub. Date: Mar. 6, 2008

(54) SYSTEM FOR PREVENTING PROCESSING DEFECT IN LASER PROCESSING

(76) Inventors: Tsunehiko Yamazaki, Aichi pref. (JP); Naoomi Miyakawa, Aichi pref. (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/768,231

(22) Filed: Jun. 26, 2007

(30) Foreign Application Priority Data
Aug. 29, 2006 (JP) JP2006-232338

(51) Int. Cl. B23K 26/03

(52) U.S. Cl. 219/121.83

(57) ABSTRACT

The invention provides a laser processing system in which a heat density accumulated in a base material is computed based on nesting data in order to create an NC program for preventing processing defects. Upon cutting out works W₁ through W₉ from a base material B₁, a nesting area N₁ is defined as a sum of the lengths of lines S₁ through S₄, which is defined as NG₁. A laser processing length dimension of the works W₁ through W₉ is computed by adding the line lengths L₁ through L₄ and the circumferential length C₁ of a round hole and multiplying the result by nine, which is defined as LG₁. The heat density HF₁ is computed as HF₁=LG₁/NG₁, and the heat density is compared with a parameter set in advance in order to determine a processing order for preventing processing defects by heat and to create a corresponding program.

The present application is based on and claims priority of Japanese patent application No. 2006-232338 filed on Aug. 29, 2006, the entire contents of which are hereby incorporated by reference.

### BACKGROUND OF THE INVENTION

1. Field of the Invention

The present invention relates to a system for preventing processing defects caused by the influence of thermal accumulation occurring during laser processing.

2. Description of the Related Art

In laser processing, when a work base material is subjected to laser processing, heat caused by the laser processing is accumulated in the work material remaining on the table. When the temperature of the portion of the work material to be newly subjected to laser processing exceeds a predetermined value, it will not be possible to realize a good processing even when laser beam is irradiated to the portion, and processing defects may be caused thereby.

Japanese Patent Application Laid-Open Publication No. 2005-334919 (patent document 1), which was filed by the present applicant, discloses a system for changing the procedure of processing based on nesting data, so as to prevent thermal influence.

### SUMMARY OF THE INVENTION

The object of the present invention is to provide a more effective system for preventing processing defect in laser processing by adding to the proposed system mentioned above the algorithm of heat density.

In order to achieve the above object, the present invention provides a system comprising a step of providing a nesting area based on nesting data and defining a length dimension surrounding the area as nesting area dimension NG₁; a step of computing a total length dimension of laser processing to be performed to all the works and for defining a total processing length dimension LG₁; a step of computing a heat density HF₁ as HF₁=LG₁/NG₁; a step of comparing the computed heat density HF₁ with a parameter set in advance; and a step of creating a program by setting a processing order of works based on the compared result.

Further, the parameter is determined by the material and plate thickness of the base material.

The system can further comprise a step of setting a heat zone subjected to thermal influence generated during processing to areas along both sides of a processing path; and a step of creating a processing program by setting a processing order of works so that the heat zone does not intervene.

Moreover, if it is not possible to prevent the heat zone from intervening even when the processing order of works is optimized, a cooling standby time which is the time until the processing can be resumed is set to the processing program; and if the cooling standby time is included in the processing program, the system further comprises a step of outputting a warning notifying that a processing defect may occur.

According to the present invention, it becomes possible to prevent processing defects by predicting the thermal influence more accurately.

### BRIEF DESCRIPTION OF THE DRAWINGS

FIG. 1 is an explanatory view illustrating the order for performing nesting upon subjecting a metal plate base material to laser processing;

FIG. 2 is an explanatory view showing the state in which nine works are nested within a nesting area of the base material;

FIG. 3 is a flow chart of a process according to the present system;

FIG. 4 is an explanatory view showing the processing order taking the heat zone into consideration; and

FIG. 5 is an output screen for warning the occurrence of processing defects caused by thermal influence.

### DETAILED DESCRIPTION OF THE PREFERRED EMBODIMENTS

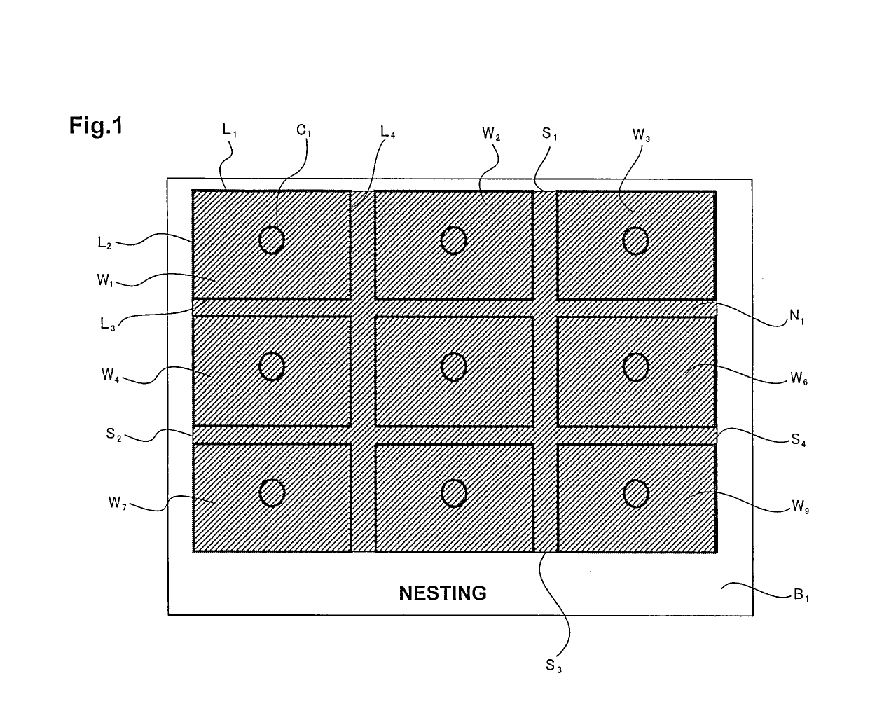

FIG. 1 shows a process for performing nesting upon subjecting a plate-shaped metal base material B₁ to laser processing.

It illustrates a case in which nine works W₁ through W₉ are nested within a nesting area N₁ shown as a shaded area.

In the illustrated example, the first work W₁ has a rectangular outer shape with a single round hole formed to the center area thereof. In this example, the length of laser processing to be provided to the first work W₁ corresponds to the length dimension of the outer peripheral sides of the work and the circumferential length of the round hole.

The length dimension of the outer peripheral sides of the work is the dimension corresponding to the total length dimension of the four sides L₁, L₂, L₃ and L₄, and the dimension of the round hole is the circumferential length C₁ of the hole.

In the embodiment of FIG. 1, nine pieces of works having the same shape are nested on the base material B₁ and subjected to laser processing. Here, the total processing dimension LG₁ corresponds to the length dimension obtained by multiplying the processing length of a single work W₁ by nine.

Next, the nesting area N₁ is the area surrounded by four sides shown by solid line S₁, S₂, S₃ and S₄. The length dimension obtained by adding the lengths of four sides S₁, S₂, S₃ and S₄ is the nesting area dimension NG₁.

In the present invention, the ratio of LG₁ to NG₁ is defined as heat density (HF₁), which is computed as follows:

HF₁(heat density)=LG₁/NG₁ (expression 1)

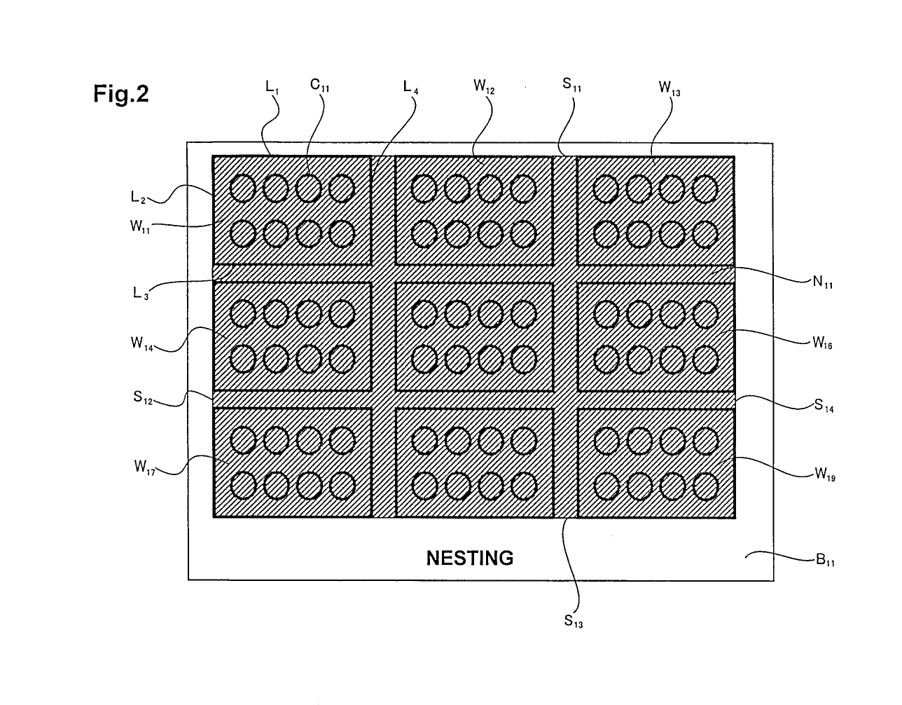

FIG. 2 illustrates a state in which nine works W₁₁ through W₁₉ are nested within a nesting area N₁₁ of a base material B₁₁.

The first work W₁₁ has a rectangular shape surrounded by four sides L₁₁, L₁₂, L₁₃ and L₁₄, having eight round holes C₁₁ formed thereto.

Therefore, the total processing length LG₁₁ of the first work W₁₁ is the sum of the lengths of four sides L₁₁, L₁₂, L₁₃ and L₁₄ plus the length obtained by multiplying the circumferential dimension C₁₁ by eight.

Similarly, the nesting area N₁₁ can be expressed as the length dimension NG₁₁ obtained by adding the lengths of four sides S₁₁, S₁₂, S₁₃ and S₁₄.

The heat density HF₁₁ in the nesting illustrated in FIG. 2 can be computed as follows:

HF₁₁=LG₁₁/NG₁₁ (expression 2)

Upon comparing the nesting of FIG. 1 with the nesting of FIG. 2, it is assumed that the four sides L₁, L₂, L₃ and L₄ of work W₁ is equal to the four sides L₁₁, L₁₂, L₁₃ and L₁₄ of work W₁₁, and the dimension of the round hole C₁ is equal to the dimension of the round hole C¹¹. Then, the processing length dimension LG₁₁ of the work W₁₁ is longer corresponding to the increased number of round holes compared to the processing length dimension LG₁ of the work W₁.

Similarly, when assuming that the nesting dimension NG₁ of FIG. 1 and the nesting dimension NG₁₁ of FIG. 2 are substantially the same, then

HF₁₁>HF₁.

The present invention provides a system for preventing in advance the occurrence of laser processing defects by computing the above-mentioned heat density.

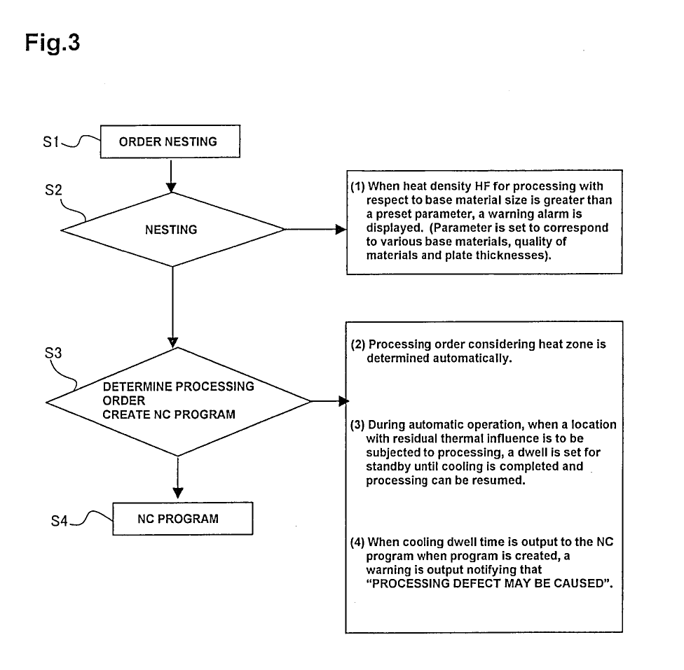

FIG. 3 is a flowchart of the process according to the system of the present invention.

When a nesting order is provided in step S1, the nesting is performed in step S2.

In the nesting step, the heat density HF described in FIGS. 1 and 2 is computed based on the nesting data. Then, when it is determined that the heat density HF is greater than a predetermined parameter, a warning alarm is displayed. The parameter is determined based on the material quality, the plate thickness and the like of the base material.

Next, in step S3, the processing order is set taking the heat zone into consideration.

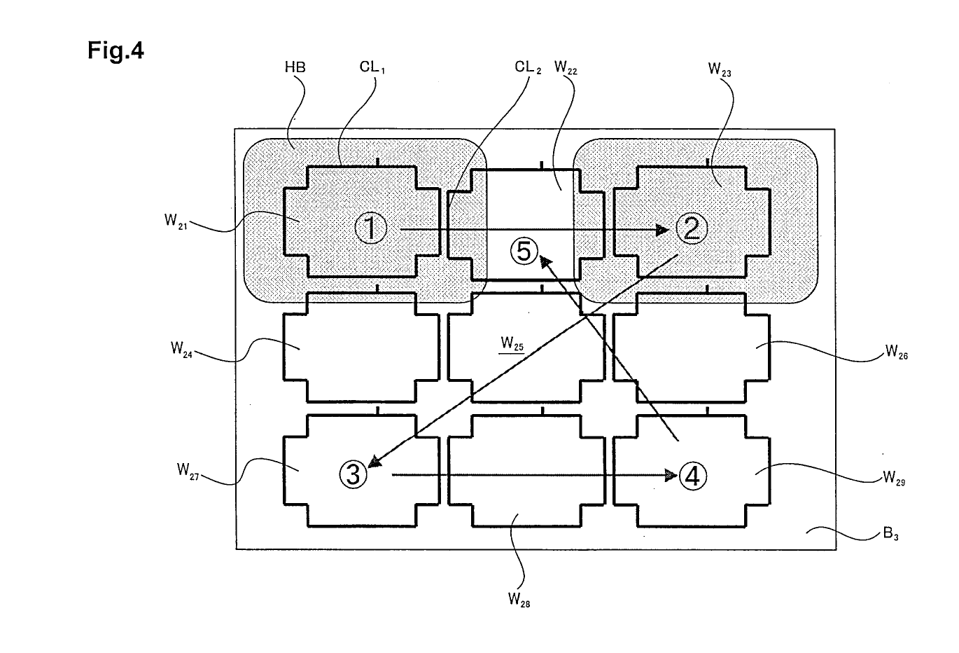

FIG. 4 illustrates the processing order taking the heat zone into consideration.

FIG. 4 illustrates the state in which nine works W₂₁ through W₂₉ are nested on a base material B₃. Each work is illustrated as the same member having a cutting line CL₁ by laser. A heat zone HB which is a heat-affected zone is set to both sides of the cutting line CL₁. The heat zone HB is determined by the material, the plate thickness, the cutting speed and the like of the base material.

If the processing order does not take the heat zone HB into consideration, it is efficient to process adjacent works W₂₁, W₂₂, W₂₃, W₂₄ through W₂₉ in the named order, since the moving distance becomes shortest.

However, if the heat zone HB of the first work W₂₁ interposes with a portion of the cutting line CL₂ of the second work W₂₂ adjacent thereto, processing defects may occur at the interposed portion.

In such case, the processing of the adjacent second work W₂₂ is skipped, and the third work W₂₃ is processed secondly. Then, the seventh work W₂₇ is processed thirdly, and the ninth work W₂₉ is processed fourthly. During this time, the heat zone of the second work W₂₂ is cooled by heat radiation and disappears.

Then, after processing the ninth work W₂₉, the processing returns to the second work W₂₂.

Thereafter, all the works are subjected to processing in a similarly determined processing order.

Even when the processing order is determined considering the heat zone as described earlier, there are cases in which the lack of heat radiation time results in residual thermal influence. If such location is subjected to processing, a dwell command is output and the processing machine enters a standby status until the processing can be resumed.

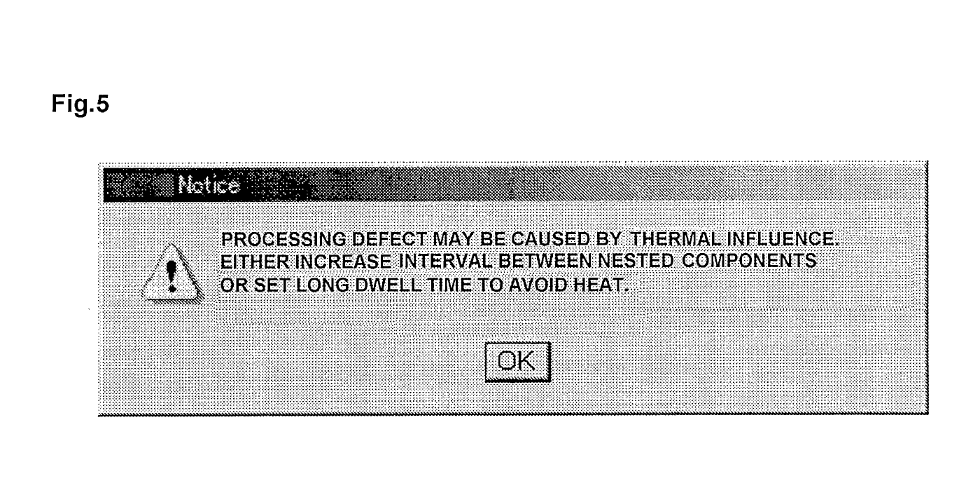

Moreover, upon creating an NC program in step S3, if the dwell time for cooling is output on the program, a warning illustrated in FIG. 5 is output notifying that “PROCESSING DEFECT MAY BE CAUSED BY THERMAL INFLUENCE. EITHER INCREASE INTERVAL BETWEEN NESTED COMPONENTS OR SET LONG DWELL TIME TO AVOID HEAT”.

After performing the above-mentioned process, an NC program is created in step S4.

What is claimed is:

1. A system for preventing processing defect in laser processing upon creating a processing program for processing a work from a base material via laser processing, comprising:
a step of providing a nesting area based on nesting data and defining a length dimension surrounding the area as nesting area dimension NG₁;
a step of computing a total length dimension of laser processing to be performed to all the works and for defining a total processing length dimension LG₁;
a step of computing a heat density HF₁ as HF₁=LG₁/NG₁;
a step of comparing the computed heat density HF₁ with a parameter set in advance; and
a step of creating a program by setting a processing order of works based on the compared result.

2. The system for preventing processing defect in laser processing according to claim 1, wherein the parameter is determined by the material and plate thickness of the base material.

3. A system for preventing processing defect in laser processing upon creating a processing program for processing a work from a base material via laser processing, comprising:
a step of providing a nesting area based on nesting data and defining a length dimension surrounding the area as nesting area dimension NG₁;
a step of computing a total length dimension of laser processing to be performed to all the works and for defining a total processing length dimension LG₁;
a step of computing a heat density HF₁ as HF₁=LG₁/NG₁;
a step of comparing the computed heat density HF₁ with a parameter set in advance;
a step of creating a program by setting a processing order of works based on the compared result;
a step of setting a heat zone subjected to thermal influence generated during processing to areas along both sides of a processing path; and
a step of creating a processing program by setting a processing order of works so that the heat zone does not intervene.

4. The system for preventing processing defect in laser processing according to claim 3, wherein if it is not possible to prevent the heat zone from intervening even when the processing order of works is optimized, a cooling standby time which is the time until the processing can be resumed is set to the processing program.

5. The system for preventing processing defect in laser processing according to claim 4, wherein if the cooling standby time is included in the processing program, the system further comprises a step of outputting a warning notifying that a processing defect may occur.
